(19) United States
(12) Patent Application Publication
(10) Pub. No.: US 2024/0027651 A1
(43) Pub. Date: Jan. 25, 2024

(54) INTERFERENCE COATINGS FOR FLEXIBLE OPTICS USING MULTILAYERED POLYMER THIN FILMS

(71) Applicant: University of Rochester, Rochester, NY (US)

(72) Inventors: Wyatt Tenhaeff, Rochester, NY (US); Yineng Zhao, Rochester, NY (US); Sheng Ye, Redmond, WA (US)

(21) Appl. No.: 18/224,404

(22) Filed: Jul. 20, 2023

Related U.S. Application Data
(60) Provisional application No. 63/390,990, filed on Jul. 21, 2022.

(51) Int. Cl. G02B 1/111; G02B 5/28

(52) U.S. Cl. CPC G02B 1/111; G02B 5/287

(57) ABSTRACT

Stretchable and compliant interference coatings for flexible optics and optoelectronic devices comprise polymeric optical thin films prepared by initiated chemical vapor deposition (iCVD) forming uniform, multilayered thin film coatings on temperature sensitive substrates at low temperature with precise thickness control. A model two-layer coating of poly(1H,1H,6H,6H-perfluorohexyl diacrylate) (pPFHDA) with a refractive index at 633 nm of n633=1.426 deposited onto poly(4-vinylpyridine) (p4VP, n633˜1.587) gives broadband performance over the visible wavelength range (400 nm to 750 nm) of a transparent, flexible thermoplastic polyurethane (TPU) substrate (n633˜1.51), reducing the front-surface reflectance from ˜4% to ˜2%, with superior mechanical compliance over conventional inorganic coatings (MgF₂, SiO₂, and Al₂O₃). Like interference coatings or three or more layers can be fabricated, where the materials and thicknesses of the layers can differ.

### REFERENCE TO RELATED APPLICATION

This patent application claims the benefit of and incorporates by reference Provisional U.S. Patent Application Ser. No. 63/390,990 filed Jul. 21, 2022.

### FIELD

This patent specification pertains to coatings useful primarily in optics to improve optical and other properties of components of optical systems.

### BACKGROUND

This patent specification includes numbers in square brackets that refer to publications fully identified at the end of the written description. Each of the cited publications is hereby incorporated by reference.

Flexible optics and optoelectronic devices require the development of stretchable and compliant antireflection coatings (ARC). A non-limiting example is lenses that are configured to change their shape to thereby change their focal length or some other property. Conventional optical coatings, typically composed of inorganic thin films, are brittle and crack with applied strain, while patterned surfaces, such as ‘moth-eye’ structure, often involved complex, multi-step processing.

Antireflection coatings (ARCs) are essential components in modern high-performance optical and optoelectronic devices. They reduce the reflection of light at the interface between the optical material and its medium, minimize undesired lens flare and glare, and increase transmission. Broadband antireflection coatings typically consist of a multiple thin film coatings with precisely engineered optical thicknesses, such that reflected light at the layer interfaces interfere destructively to minimize reflectance [1-4]. Practical broadband antireflection coating designs require thin film materials that: 1) are transparent in the desired wavelength range (minimal absorption and scattering); 2) offer a wide range of accessible refractive index; 3) can be deposited with high thickness precision; 4) possess good mechanical properties, such as adhesion to the substrate; and 5) are chemically and physically stable in the targeted environment.

Conventional antireflection coatings are dominated by inorganic compounds, such as MgF₂, Al₂O₃, SiO₂, and TiO₂.[1, 4-6] Inorganic fluoride, oxide, and sulfide compounds offer excellent transparency over a broad wavelength range, from near-UV to near-IR, and a wide range of accessible refractive indexes. MgF₂ possesses one of the lowest refractive indexes (˜1.38) among dense layers. It is widely used as single-layer ARC for common glass (index ˜1.51; ideal index of its single-layer ARC is ˜1.23), as well as the low index component in multilayer ARCs [1]. TiO₂ has a reported index of 2.56 [7], providing an index contrast of 1.18 relative to MgF₂, which is oft-exploited in ARC designs [8-10]. Moreover, these materials are stable in air over wide ranges of temperature and humidity. Some of these layers find application as transparent barrier layers, replacing opaque metallic thin films [11-13]. Given the importance of these inorganic thin films, a multitude of vacuum deposition techniques based on either physical vapor deposition or chemical vapor depositions have been developed, providing high throughput fabrication of precisely controlled optical layer designs.

The brittleness of inorganic-based ARCs is a significant limitation when applied to flexible, elastomeric substrates, which are being explored for advanced optical systems. As optical and optoelectronic devices are becoming increasingly compact, flexible, and adaptive in recent years—the development of wearable displays, adaptive augmented reality/virtual reality hardware, and flexible photovoltaics are a few examples—ARCs that can be incorporated with flexible substrates are desirable [14-18]. However, the mismatch in elastic properties and coefficients of thermal expansion between the optical layers and polymeric substrate results in facture (cracking) and/or film delamination with slight strain or temperature excursions [17]. Even minute moisture absorption can lead to volumetric stresses that result in coating failure [19]. Another practical challenge can arise due to the heat flux on the polymer substrate during vacuum deposition [20], which can lead to undesirable morphological changes in the polymeric substrate and/or residual film stresses [21].

Polymer thin film coatings, possessing elastic properties and thermal expansivities that are comparable to the underlying substrate, would be better suited for flexible optics, yet an important limitation is their limited range of refractive indexes. Conventional thermoplastics have refractive indexes that fall into a relatively small range—approximately between 1.35 to 1.70 [22]. This index contrast of 0.35 is markedly less than that can achieved with established inorganic coatings [23, 24]. To compensate for this limited index contrast, one design strategy is to increase the number of layers in the multilayer coating to give higher degree of freedom in manipulating interference so more significant antireflection over a larger bandwidth can be achieved [25]. However, the fabrication of multiple polymer layers with nanometer-level precision in thickness is a challenge for conventional solution processing. Wet coating techniques, such as spin coating and dip coating, usually require sequentially application of polymers from solutions. However, the solvents can also cause swelling and even dissolution of the previously coated layers [26-28]. Careful selection of polymer combinations with orthogonal solubilities can mitigate these problems but at the expense of design freedom [29-31], and solvent penetration into the multilayer structure can still damage buried layers and lead to deleterious film stresses that compromise the coating [28, 32]. Another technique, melt polymer coextrusion, can fabricate large number of polymer multilayers at scale with thickness down to tens of nanometers of each layer [33-35]. However, the film stacks usually consist of layers with repeated thickness combinations—individual layer thicknesses cannot be freely tuned. Moreover, its thickness control is highly dependent on a precise control on the laminar flow of melt polymers and a thorough understanding of the rheological behavior of each polymer during the coextrusion [36]. Both solution processing and coextrusion techniques lack the key ability to in situ monitor nascent film thickness during fabrication, which complicates reproducible thickness control and tuning. Vacuum deposition techniques, on the other hand, enable in situ monitoring of layer thicknesses during sequential multilayer deposition. Only a select few polymers can be deposited by physical vapor deposition, such as sputtering, pulsed laser, or thermal evaporation, and the process often leads to chain fragmentation and other compositional defects [37-41]. Molecular layer deposition (MLD) and conventional CVD offer greater control over film chemistries, but often require elevated temperatures, making integration with temperature-sensitive thermoplastic substrates difficult. Finally, plasma-enhanced CVD (PECVD) is a well-established technique [43], but the energetic plasma generates a distribution of highly reactive intermediates [26]. Another promising approach alternative to coatings is to engineer antireflection through surface patterns or porous structures directly applied to the flexible substrate, but their complex multi-step fabrication processes and limited mechanical durability currently limit their practical implementation [2, 44-47].

### SUMMARY

The summary below reflects the initially claimed subject matter, which can evolve in prosecution of this patent application.

According to some embodiments, an optical device comprises: a flexible substrate; and a polymer interference coating integrated with the substrate to form therewith a flexible optical structure that remains crack-free after 100 or more strain cycles at 1% or greater strain; wherein said interference coating comprises an in-situ synthesized layer of polymerized 4-vinylpyridine (p4VP) and an in situ synthesized layer of polymerized 1H,1H,6H,6H-perfluorohexyl diacrylate (pPFHDA) sequentially deposited on the substrate in an initiated chemical vapor deposition (iCVD) process.

The optical device may further include one or more of the following: (a) the substrate can comprise an aliphatic thermoplastic polyurethane (TPU) elastomeric substrate; (b) cracks in the ARC caused by imperfections in the substrate and application of strain to the interference coating exceeding a first strain threshold self-heal upon reduction of strain to below a second strain threshold; (c) the first threshold can be ε=1% or more equibiaxial strain and the second threshold can be less than ε=0.3% equibiaxial strain; (d) the interference coating can consist of only two layers, one comprising said p4VP and one comprising said pPFHDA; (e) said interference coating comprises plural, alternating layers of said p4VP and pPFHDA; (f) the pPFHDA layer can be over the p4VP and can function as a barrier layer; (g) the thickness of each of said layers can be under 200 nm and the areal variation in thickness of each layer can be less than 3%; (h) said interference coating can have the property of withstanding at least ε=1.64% equibiaxial strain without fracture; said interference coating can have the property of withstanding at least ε=1.64% equibiaxial strain over hundreds of cycles without fracture; (i) adding said interference coating over the substrate can reduce by at least 5% the reflectance of the device compared to reflectance of the substrate in the wavelength range of 400-1,000 nm; and (j) adding said interference coating over the substrate increases by at least 1.5% the transmittance of the device compared to transmittance of the substrate in the wavelength range of 400-750 nm.

According to some embodiments, a method of forming an optical device comprises; depositing a first monomer and an initiator to conformally deposit a first polymerized layer on a flexible elastomer substrate and depositing a second monomer and an initiator on the first polymerized layer for form a second polymerized layer; wherein said first and second polymerized layers form a flexible interference coating integrated with the substrate in an iCVD process; and wherein said interference coating has the property of remaining crack-free after 100 or more strain cycles at ε=1% or more equibiaxial strain without fracture.

The method can further comprise one or more of the following: (a) said first monomer can comprise 4-vinylpyridine (4VP) and said second monomer can comprise 1H,1H,6H,6H-perfluorohexyl diacrylate (PFHDA); (b) said substrate can comprise aliphatic thermoplastic polyurethane (TPU) elastomeric substrate; (c) said iCVD process can comprise injecting a non-reactive gas into said first monomer when in liquid form to cause a forced vapor delivery of the first monomer over said substrate into a reaction chamber to form a layer of said first monomer on the substrate, introducing in said reaction chamber an initiator as vapor that is free of carrier gas and is heated to form gas-phase radicals to thereby polymerize the first monomer into said first polymerized layer, thereafter injecting said non-reactive gas into said second monomer when in liquid form to cause a forced vapor delivery of the second monomer into the reaction chamber and over said first polymerized layer to form a layer of said second monomer, and introducing in said reaction chamber the initiator as vapor that is free of carrier gas and is heated to form gas-phase radicals to thereby polymerize the second monomer into said second polymerized layer and form said interference coating; (c) said initiator can comprise di-tert-butyl peroxide (TBPO); (d) said depositing can be carried out at room or near-ambient temperature; (e) the method can include maintaining said substrate at a constant temperature during said depositing; (f) the method can comprise repeating said depositing step to form interference coating comprising a repeating sequence of said first and second polymerized layers.

The According to some embodiments, an optical device comprises: a flexible elastomer substrate; a first monomer conformally deposited over said substrate and polymerized in situ by an iCVD process to form a first polymerized layer over the substrate; and a second monomer deposited over the first polymerized layer and polymerized in situ by an iCVD process to form a second polymerized layer; wherein said first and second polymerized layers form a flexible polymer antireflection coating (ARC) integrated with the substrate; and wherein said ARC with the property of remaining crack-free after 100 or more strain cycles at ε=1% or more equibiaxial strain without fracture.

According to some embodiments, the optical device described in the immediately preceding paragraph can further comprise one or more of the following: (a) the device can include one or more additional monomers sequentially deposited over the second polymerized layer and polymerized in situ to respectively form one or more additional polymerized layers, wherein said first and second and said one or more additional polymerized layers form said flexible interference coating integrated with the substrate; (b) at least two of said first and second and said additional one or more polymerized layers can have respective thicknesses that differ from each other; (c) the material of at least two of said first and second and said one or more additional polymerized layers can be the same; (d) the material of each of said first and second and said one or more additional polymerized layers differs from that of every other layer; (e) the monomers can be selected from among Fluorocarbon, organosilicon, acrylate, methacrylate, styrenic and other vinyl monomers' (f) the monomers can be selected from among hexafluoropropylene, tetravinyltetramethyltetrasiloxane, butyl acrylate, butyl methacrylate, divinylbenzene, and vinyl pyrrolidone; and (g) the first and second polymerized layers can comprise an in-situ synthesized layer of polymerized 4-vinylpyridine (p4VP) and an in situ synthesized layer of polymerized 1H,1H,6H,6H-perfluorohexyl diacrylate (pPFHDA).

### BRIEF DESCRIPTION OF THE DRAWINGS

To further clarify the above and other advantages and features of the subject matter of this patent specification, specific examples of embodiments thereof are illustrated in the appended drawings. It should be appreciated that these drawings depict only illustrative embodiments and are therefore not to be considered limiting of the scope of this patent specification or the appended claims. The subject matter hereof will be described and explained with additional specificity and detail using the accompanying drawings in which:

FIG. 1A illustrates a system for iCVD of a multi-layer, flexible antireflection coating (ARC) on a flexible substrate, according to some embodiments.

FIG. 1 shows a structure of a two-layer interference coating on TPU at upper left, in panel (a); optical constants of individual polymer layers in the design: p4VP and pPFHDA at upper right, in panel (b); contour map of the thicknesses of the two-layer ARC at lower left, in panel (c), of a p4VP layer in lower middle, in panel (d), and of a pPFHDA layer on TPU at lower right, in panel (e), according to some embodiments. The mapped area is 18.1 cm2.

FIG. 2 shows FTIR-ATR spectra of a two-layer polymer coating on TPU, pPFHDA homopolymer, p4VP homopolymer, and bare TPU substrate at fingerprint region from 1800 cm−1 to 700 cm−1, according to some embodiments. Homopolymers spectra were acquired from iCVD films deposited on Si wafers separately. ATR correction was applied. (‘s’ denotes stretching.)

FIG. 3 shows surface topography of a two-layer polymer interference coating at left, in panels (a-c); pf 261 nm MgF2 in the middle, at panels (d-f); and at right, in panels (g-i), of 30 nm MgF2 film measured in situ as a function of increasing equibiaxial strain of ε=0.3% in panels (a, d, g); ε=0.84%) in panels (b, e, h), and ε=1.64% in panels (c, f, i), according to some embodiments. The scanned area was 400×300 μm.

FIG. 4 shows surface topography of a 25 nm SiO2 coating at the upper half, in panels (a-c); of 38 nm Al2O3 coating on in the bottom half, in panels (d-f); monitored with increasing equibiaxial strain ε=0.3% in panels (a, d), ε=0.84% in panels (b, e), and ε=1.64% in panels (c, f), according to some embodiments. The scanned area was 400×300 μm.

FIG. 5 shows a polymer two-layer interference coating (258 nm) imaged after repeatedly strained to ε=1.64% 80 times in panel (a) and after strain released to ε=0.3% in panel (c); 261 nm-MgF2 imaged during the first strain at ε=1.64% panel (d) and after strain released to ε=0.3% on panel (f); depth profile cross cracks on the polymer interference coating surface in panel (b), and MgF2 along the indicated lines shown in the images in panel (e), according to some embodiments.

FIG. 6 shows reflectance spectra of TPU coated with polymer interference coating before and after repeated equibiaxial strain compared to that of uncoated TPU in panel (a); the reflectance evolution of the ARC-coated TPU at the visible range (400-750 nm wavelength) during repeated strain cycles in panel (b).

The backside (uncoated) reflection of the TPU is included in the measurement. Panel (c) shows total transmittance of the bare TPU and polymer interference coating-coated TPU after 200 strain cycles (ε=1.64%), according to some embodiments.

FIG. 7 shows simulated reflectance of TPU coated with interference coating constructed by 6 layers of alternating p4VP/pPFHDA films, 2 layers of p4VP/pPFDA films, 2 layer of p4VP/pPFHDA according to some embodiments, and the bare TPU as reference. Backside reflection (BSR) is not included in the calculation.

FIG. 8 schematically illustrates a substrate with a multi-layer interference coating in which the materials for the layers and the layer thicknesses can differ and the number of layers can be two or more.

Fig. S1 shows FTIR-ATR spectra of a two-layer polymer coating on TPU, pPFHDA homopolymer, p4VP homopolymer, and bare TPU according to some embodiments. ATR correction was applied. (‘d’ denotes deformation; ‘s’ denotes stretching.)

Fig. S2 shows FTIR-ATR spectra of a two-layer polymer coating on TPU, p4VP homopolymer, according to some embodiments, and bare TPU, between 3120 and 2800 cm−1, ATR correction was applied during data collection. (‘s’ denotes stretching.)

Fig. S3 shows FTIR-ATR spectra of a 4VP monomer in panel (a) and p4VP homopolymer in panel (b) and PFHDA monomer and pPFHDA homopolymer between 2000 and 650 cm−1 in panel (b), according to some embodiments. ATR correction was applied during data collection. (‘r-’ denotes ‘pyridine ring’; ‘op’ and ‘ip’ denote ‘out-of-plane’ and ‘in-plane’; ‘d’ denotes deformation; ‘s’ denotes stretching.)

Fig. S4 shows a bulging device with illustration of an in situ profilometry set-up, according to some embodiments.

Fig. S5 shows thickness contour map of a thick and a thin MgF2 coating on TPU, in panels (a) and (b) respectively, measured ellipsometrically, according to some embodiments. The mapped area is 18.1 cm2.

Fig. S6 shows surface topography of a two-layer polymer interference coating coated TPU measured at zero strain before and after the first application of strain to ε=1.64% in panels (a) and (b) respectively, according to some embodiments. The scanned area is 400×300 μm.

Fig. S7 shows surface topography of a 261 nm MgF2-coated TPU measured at zero strain before application of strain, according to some embodiments. The scanned area is 400×300 μm.

Fig. S8 shows thickness contour maps of SiO2 and Al2O3 coatings on TPU, measured by ellipsometry, in panels (a) and (b) respectively, according to some embodiments. The mapped area is 18.1 cm2.

Fig. S9 shows complex refractive index of the SiO2 and Al2O3 coating on an indicator Si wafer positioned next to the TPU substrate during the deposition, in panels (a) and (b) respectively, according to some embodiments.

Fig. S10 shows an optical microscope image of bare TPU before coating.

Fig. S11 shows surface topography of a two-layer polymer coating on TPU, measured in a state after the formation of the first cracks were detected, according to some embodiments. The scanned area is 400×300 μm.

Fig. S12 shows a depth profile of a 261 nm-MgF2 coating measured along the same line indicated at FIG. 5 in panel (d), according to some embodiment. Measurement taken after first strain test with stress released to 0.3%.

Fig. S13 shows surface topography of a 25 nm-SiO2 and 38 nm-Al2O3 coatings on TPU in panels (a) and (b) respectively, measured in unstrained state after cracks first appeared, according to some embodiments. The scanned area is 400×300 μm.

Fig. S14 shows complex refractive index by ellipsometry of the bare TPU.

Fig. S15 shows calculated reflectance of bare TPU and polymer AR-coated TPU with backside reflection included, according to some embodiments. The numbers appearing in the legend are the average reflectance over the coating over visible wavelengths (400−750 nm).

### DETAILED DESCRIPTION

A detailed description of examples of preferred embodiments is provided below. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description to provide a thorough understanding, some embodiments can be practiced without some or all these details. Moreover, for the purpose of clarity, certain technical material that is known in the related art has not been described in detail to avoid unnecessarily obscuring the new subject matter described herein. Individual features of one or several of the specific embodiments described herein can be used in combination with features of other described embodiments or with other features. Further, like reference numbers and designations in the various drawings indicate like elements.

Polymer multilayers as transparent optical interference coating are formed on a flexible and heat-sensitive substrate, suitable for flexible optics where conventional inorganic optical coatings become unsuitable because of their brittleness. Initiated-chemical vapor deposition (iCVD) creates the polymer multilayers at room temperature. Polymer multilayers created by other solvent-based methods or co-extrusion are limited in feasibility or too complicated in processing, such as limited choices of materials, involving multi-step treatment, lack of precise thickness control methods, highly sensitive to reproducibility, requiring a beforehand understanding of thermal and rheological behavior of the processed polymer. In contrast, due to the advantage of sequential and in-situ synthesis of each polymer layer directly on a substrate, as described in this patent specification, polymerization chemistry can be well defined, solubility or thermal/rheological behavior is not a concern, and in situ ellipsometry, reflectometry, and/or quartz crystal microbalance (QCM) can be used to in situ monitor and control the thickness of the coating during the deposition down to nanometers; these render a well-defined optical property, a broadened feasibility of polymer materials, a thickness control insensitive to the reproducibility of deposition rate, and finally making highly complex interference coating by polymers possible.

A polymer two-layer antireflection coating (ARC) on a flexible substrate is one example of the application of such polymer interference coating. Poly(4-vinylpyridine) with a refractive index at 633 nm of n633=1.587 and poly(1H,1H,6H,6H-perfluorohexyl diacrylate) (pPFHDA, n633=1.426) are two example polymers used to compose the two-layer ARC. In one example, the polymers are deposited sequentially onto a membrane of thermoplastic polyurethane (TPU) to examine its optical and mechanical properties. The successful synthesis of the coating was proved by FTIR and ellipsometry. The coating polymers showed no detectable light absorptions (extinction coefficient κ<10⁻⁸) from 360 nm to 1690 nm wavelength. Superior flexibility and resistance to fracture compared to several conventional inorganic optical coatings (MgF₂, SiO₂, Al₂O₃) have been proved since no sign of crack was detected on polymer coating after it was strained to 1.64% equi-biaxially. In contrast, all the inorganic coatings examined fractured into small pieces at the first strain. Broadband antireflection (reflectance reduced from ˜4% to ˜2%) over the visible range and its excellent durability were demonstrated by stable reflectance spectra collected during repeated strain cycles (ε=1.64% equi-biaxial, >200 cycles) applied to the coating. Increased transmittance of the TPU substrate after being coated with the two-layer polymer ARC, even after 200 strain cycles applied, categorically proved the excellent transparency and antireflection performance of the coating from both optical and mechanical aspects. Other combinations of polymer materials, layer thicknesses, and the number of layers for the interference coating structure are addressed infra.

According to some embodiments, initiated chemical vapor deposition (iCVD) deposits a model two-layer polymeric antireflection coating on an aliphatic thermoplastic polyurethane (TPU) elastomeric substrate with designed structure. The two polymer layers were poly(1H, 1H, 6H, 6H-perfluorohexyl diacrylate) (pPFHDA) and poly(4-vinyl pyridine) (p4VP), which have distinct refractive indexes of 1.43 and 1.59, respectively (reported at 633 nm). iCVD is a vacuum deposition technique [43, 48-50] capable of conformally depositing uniform polymer thin films near room temperatures, which is important to avoid unwanted phase transformations and/or thermal stresses in the substrate. The solvent-free nature of the technique is especially significant as it spares the multilayered systems from complications associated with swelling or dissolution as discussed above. Moreover, through precise control of the process chemistry, polymer film compositions can be carefully engineered to tune optical properties, and crosslinking can be incorporated as needed to modulate mechanical properties [51]. It has been reported that the highly crosslinked pPFHDA used in examples described in this patent specification as the top layer also functions as a highly effective barrier layer [52].

The examples described herein demonstrate for the first time, to applicant's knowledge, the preparation of a fully polymeric model two-layer antireflection coating by iCVD and explore the mechanical compliance relative to other conventional inorganic optical layers through direct in situ evaluation of coating failure as a function of applied equibiaxial strain. The work is an innovation over previous studies where pPFHDA-based barrier layers were deposited onto flexible TPU substrates with compositional fidelity, thickness uniformity, and adhesion [52]. Several conventional coating materials (MgF₂, SiO₂, Al₂O₃) and thicknesses were also explored to understand the generality of film cracking in inorganic materials coated onto elastomeric substrates. Subsequently, cracks were deliberately generated in the polymer coating through cyclic application of aggressive strain to monitor their evolution over time and effect on antireflection performance.

For a reflection from one surface of a common glass or plastic with index around 1.5, but no backside reflection, reflectance can be reduced from ˜4% to ˜2% with pPFHDA/p4VP two-layer ARC. With backside reflection, the reflectance from both front-side and back-side would be around 7.8% for a similar substrate, and applying such ARC to one side, can reduce the combined frontside and backside reflectance to ˜5.8%. The backside not coated by ARC has its reflectance not impacted. Reducing backside reflectance is doable by applying such ARC on the backside as well as the front side. By using other polymer material (pPFDA) or adding more layers, the reflectance from one side of TPU can be reduced to 0.8% or less. The optical performance of an antireflection coating or any interference coating is dependent on the optical properties of the substrate it applies onto. To reach a targeted optical property by optical coating, the coating design—including number of layers, sequence of layers, refractive index required or available for each layer, thickness of each layer should be tailored exactly according to the goal and the substrate. Therefore, the design and optimal performance varies for each individual case. The optimal performance also varies by the design and the substrate. In the work described in this patent specification, a demonstration was made on a specific case of targeted optical property, which is antireflection on TPU substrate; it then leads to this specific multilayer design. However, it is the concept of using iCVD to apply polymer multilayers as the optical coating that was validated here. The approach described in this patent specification is not limited to be this specific two-layer design, not limited to the polymer material choices, not limited to the thickness choices, not limited to two layers, not limited to TPU substrate, not limited to antireflection.

### Preparation of the Two-Layer Polymer Interference Coating by iCVD—Chemical Structure Analysis

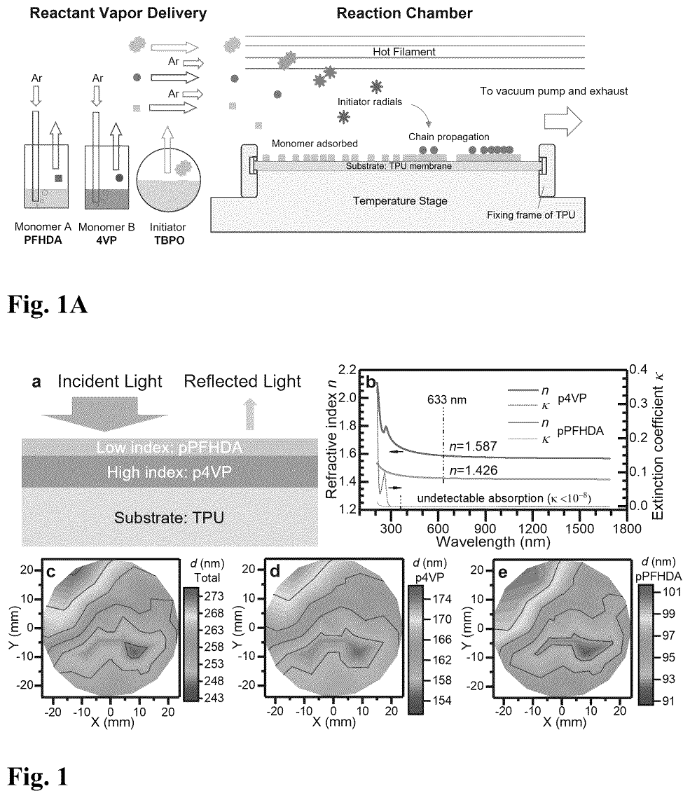

According to some embodiments, a two-layer polymer interference coating was prepared by a custom-built iCVD system schematically depicted in FIG. 1A. A layer of p4 VP and a second layer of pPFHDA were sequentially deposited onto a soft TPU substrate, forming the structure illustrated at upper left of FIG. 1, at panel (a). The monomers, 4-vinylpyridine (4VP) and 1H,1H,6H,6H-perfluorohexyl diacrylate (PFHDA), were separately introduced into the vacuum chamber seen in FIG. 1A using a bubbler system, which injects argon through a dispersion tube into liquid monomer carrying the vapor into the reaction chamber. This forced vapor delivery enables deposition of monomers with low volatility, which are otherwise infeasible in conventional iCVD relying on vapor pressure for flow [52]. The initiator, di-tert-butyl peroxide (TBPO), was introduced as vapor (without carrier gas) and decomposed by the illustrated hot filament to form gas-phase radicals. The two-step initiation process is considered complete after the radicals encounter adsorbed monomers on the substrate. Gas phase reactions of the radicals is believed insignificant due to the low chamber pressure of 750 mTorr, ensuring heterogenous polymerization on the surface and conformal coatings with controllable chemical compositions [43, 53, 54]. The substrate was placed on a temperature stage to keep the temperature constant and stable, usually around room temperature (30° C.).

An example of the structure of the two-layer interference coating is shown at upper left in FIG. 1, in panel (a), with the high index p4VP next to the substrate and the low index pPFHDA on top. The complex refractive index of p4VP and pPFHDA were characterized by ellipsometry and plotted at upper right in FIG. 1, in panel (b). The refractive indexes of p4VP and pPFHDA are 1.59 and 1.43 at 633 nm, respectively. The imaginary component of refractive index, the extinction coefficient, shows both polymers have negligible absorption (κ<10⁻⁸) from near-UV (360 nm) to near-IR (1690 nm)—valuable for optical transparency. The total thickness of the two-layer system and the individual films were mapped over the TPU substrate using ellipsometry—see remainder of FIG. 1, in panels (c) through (e). The total thickness of two-layer interference coating is 258 nm with ±7.0 nm standard deviation. The thickness of p4VP and pPFHDA are 163±4.8 nm and 96±2.4 nm, respectively—evidence of the excellent uniformity of iCVD films. Judging by the similar thickness distribution in both layers, the areal thickness variation is likely induced by a local temperature difference due to imperfect contact between the TPU membrane substrate and the temperature stage coupled to the low thermal conductivity of the TPU substrate. In iCVD, deposition rate is highly correlated to substrate temperature, which governs adsorption of monomers to the surface; low temperatures result in a larger monomer concentration and a higher deposition rate [43, 53-55]. The uniformity was similar to that achieve in a previous study of a single-layer pPFHDA [52]. Therefore, high uniformity was preserved for multilayer coatings by iCVD, which helps achieve a meaningful thickness control and optical coating fabrication.

### Chemical Structure Analysis

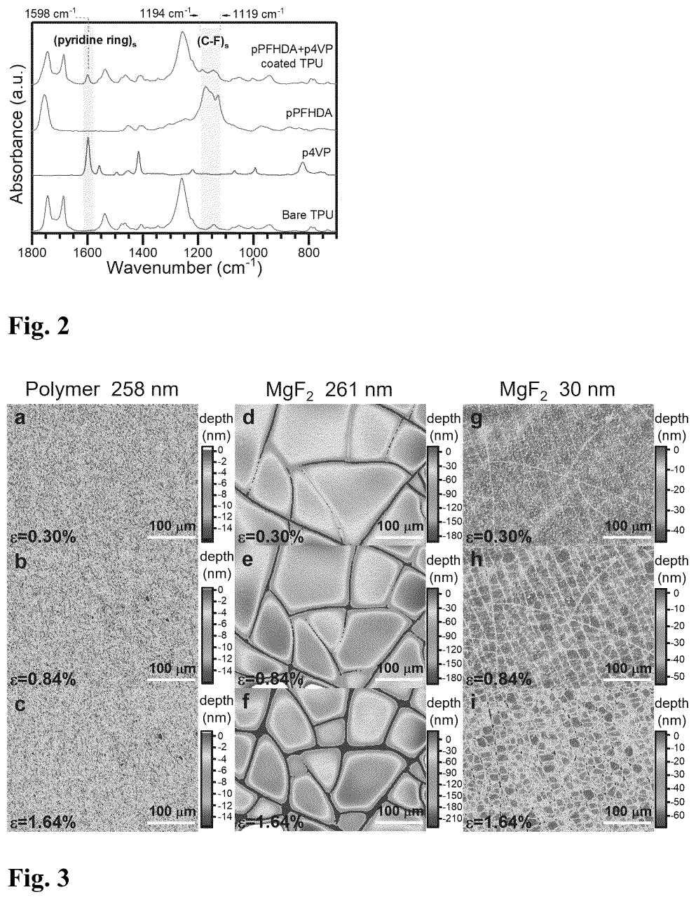

Fourier-transform infrared spectroscopy (FTIR) was used to characterize the chemical composition of the coating in the example described above. The spectra of the two-layer polymer coating on TPU, pPFHDA homopolymer, p4VP homopolymer, and bare TPU from 1800 cm⁻¹ to 700 cm⁻¹ (the “fingerprint” region of the spectra) are shown in FIG. 2. The full spectra over the entire mid-infrared range are shown in Fig. S1. The strong quadrant stretch mode characteristics of the pyridine ring at 1598 cm⁻¹ are observed in both the p4VP homopolymer and the coated TPU but not in the other spectra. Also, in Fig. S2, aromatic C—H stretch modes of the pyridine ring in p4VP are observed in the coating, indicating that p4VP was successfully incorporated into the coating. It is important to note that the evanescent wave from the diamond prism of the ATR has a penetration depth of approximately 1 μm—much larger than the coating thickness. Thus, the spectrum of the two-layer coating is dominated by the TPU vibrational modes. Despite pPFHDA layer being less than 100 nm thin, the strong symmetric and asymmetric C—F stretching modes of —CF₂— observed in the pPFHDA homopolymer are also present in the coated TPU—no other vibrational modes from bare TPU or p4VP in this wavelength range. This indicates the existence of pPFHDA in the coating of TPU. In addition, a comparison of IR spectra between the monomers and the coated homopolymers on a Si wafer are shown in Figure S3. The C═C stretching mode at 1637 cm⁻¹ in PFDA (medium intensity) and the ═C—H out-of-plane deformation band of the vinyl group at 927 cm⁻¹ in 4VP (strong intensity) [56], are absent in the polymer coatings, indicating that the monomers have been fully polymerized and few residual vinyl groups remain. Hence, it can be concluded that the two-layer coating of pPFHDA and p4VP coating has been successfully prepared on the TPU substrates by iCVD.

### In Situ Coating Surface Topography with Progressing Strain: Polymers vs Inorganics

To assess the fracture resistance of the polymer interference coating and its superiority over inorganic coatings for flexible optics, an in situ characterization method was designed to compare their fracture behavior with applied strain. Progressive equibiaxial strain was generated stepwise using an established approach [57, 58] (experimental configuration shown in Fig. S4), where pressure was applied pneumatically to the coated TPU samples. The cell was placed under a white-light interference profilometer, so the surface topography evolution of the coatings could be monitored in situ. Profilometry images were collected at strains of ε=0.30%, ε=0.84%, and ε=1.64%, which were calculated by Equation (1) infra using previous pressure-deflection calibration measured with a laser profiler. A larger strain was not attempted as the corresponding deflection exceeded the maximum measurable by the laser profiler. Initially, comparisons were made between the polymer ARC and films of MgF₂, a conventional inorganic ARC material used as a control sample. MgF₂ films (thickness mapping by ellipsometry shown in Fig. S5 in panels (a) and (b) were deposited onto the TPU substrates by electron-beam evaporation. FIG. 3 in panels (a)-(c) reveals how the surface topography of the polymer ARC evolves—no sign of any cracks was observed even after it was strained to an aggressive value of 1.64%. It is worth to note that flexible optics such as electrically tunable lenses usually involve an applied strain much less than 1%, which is usually limited by the voltage requirement by an electrostriction mechanism [59, 60]. The polymer interference coating can readily accommodate these strains. The profilometry images before and after the strain was also presented in Fig. S6, panels (a) and (b), and the areal roughness analyzed from them kept unchanged at 2.7 nm (mean square root height). This indicates a very smooth surface was obtained, which is crucial to minimize light loss from scattering.

In contrast, the MgF₂ coating at comparable thickness (261 nm) fractured into several fragments, resulting in the commonly observed “mud-cracking” phenomenon [57]. This was consistent with expectation and previously reported studies of the behavior of a brittle inorganic coating on flexible substrate under strain [57, 58, 61]. Even at the lowest applied strain (ε=0.3%, FIG. 3 in panel (d), the MgF₂ had clearly fractured. As the strain increased, new cracks were initiated (see FIG. 3 in panels (d)-(f); the MgF₂ coating fractured to smaller fragments and the width of the cracks also expanded. In fact, cracks could be observed even before any strain was applied externally (Fig. S7), likely due to a large mismatch in elastic properties and/or thermal expansivity between the hard MgF₂ coating and the soft TPU polymer substrate [62-65]; a slight change in temperature and/or humidity in the environment can induce significant internal stress [19, 66]. Because film internal stress is proportional to film thickness, a much thinner (30 nm) film of MgF₂ was deposited onto TPU for fracture characterization to make the experiment more stringent.[61] The 30-nm thickness is also closer to the lower limit of layer thicknesses applied in real multilayer antireflection designs [25]. As expected, FIG. 3 in panel (g) reveals fewer cracks in the 30 nm MgF₂ films at low strain (ε=0.3%) relative to the 261 nm-MgF2 coating; the width of each crack is also appeared to be less. According to Andersons and Leterrier, [58] the cracks at this initial stage have large spacing, which is consistent with observation in the example described here, and they primarily reflect the defect distribution in the coating. However, when the strain increased to ε=0.84% (FIG. 3 in panel (h)), a large number of cracks formed almost instantaneously, and the coating was fragmented into numerous small pieces. This could indicate the stress transferred from the polymer substrate reaches the strength of the coating so it fragmentated until the size of individual piece was reduced to below a critical value where the stress exerted upon no longer exceeded its strength [58]. Further increasing the strain to ε=1.64% (FIG. 3 in panel (i)) leads to an expansion of crack width as observed in the thicker coating. Therefore, it can be concluded that MgF₂ coatings, regardless of thickness, are likely to fracture, even at a small strain of 0.3%, and do not remain intact on flexible substrates.

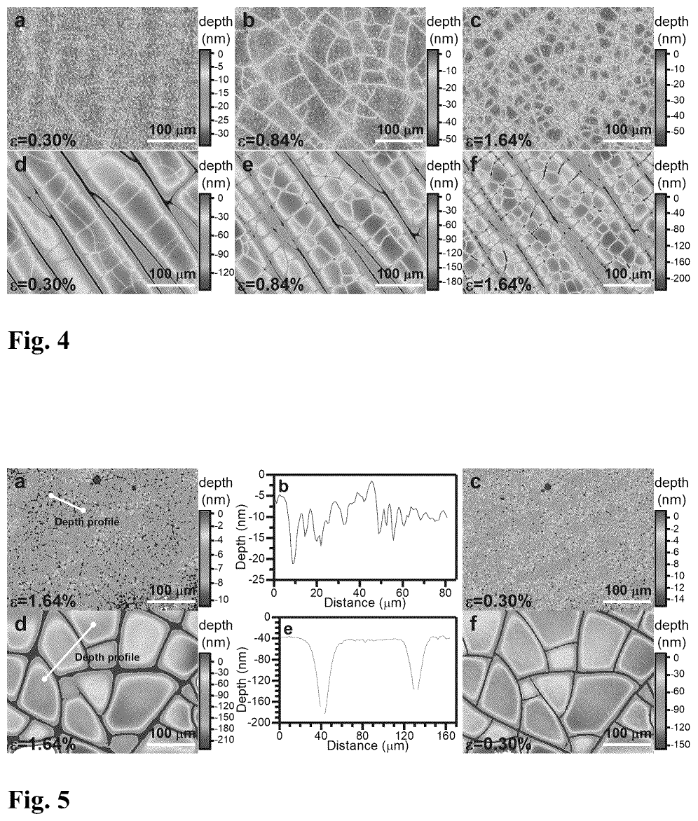

FIG. 4 in panels (d) and (f) displays the surface morphology of 38 nm-Al₂O₃ coated sample with increasing strain. The alumina-coated TPU possessed a wrinkled morphology. The characteristic periodicity of these wrinkles was several hundred micrometers, and the depth of the “valleys” was in the range of several hundreds of nanometers—much larger than the 38-nm Al₂O₃ coating. This morphology is attributed to residual coating stresses due to thermal effects during the evaporation. Alumina required a higher e-beam current for evaporation, which resulted in a more severe radiative heating of the substrate than in SiO₂ or MgF₂ depositions. Though the exact temperature of the substrate was not available, the TPU frame was warm to the touch upon removal from the chamber; this was not the case after coating the other materials. This temperature excursion during deposition likely resulted in thermal expansion of the TPU, which then contracts upon cooling to room temperature, resulting in residual film stress and attendant wrinkling of the substrate [67-69]. This is a phenomenon that has been exploited to characterize mechanical properties of thin film coatings [70-72]. It also further emphasizes the challenges associated with residual film stresses due to mismatches of coefficients of thermal expansion [17] Thus, the ability of iCVD to coat materials at near-ambient temperatures as described in this patent specification is an important feature of the deposition method. Even with the wrinkled morphology, the fracture behavior of alumina thin films with applied equibiaxial strain can still be observed. Alumina revealed the same behavior of the other inorganic materials—fracturing into multiple smaller fragments with increasing strain.

To further challenge the durability of a two-layer polymer interference coating, the surface topography of the film was characterized after repeated strain of the TPU. After aggressively strained 80 times to ε=1.64%, the strained surface was imaged in situ (FIG. 5 in panel (a)). Some small cracks can be observed, which were absent initially (FIG. 3 in panel (c)); they only appeared after repeated strain cycling. The cracks appear to emanate from pinhole-like defects. These ‘pinhole’ defects were widely observed on the pristine uncoated TPU membranes, as shown in Fig. S10. Thus, it is possible that the polymer coating is imperfect and discontinuous at these point defects, which combined with stress concentration upon application of strain, leads to crack initiation. Moreover, the cracks appear to only radiate from the defect points for a limited length without intercepting each other. The majority of the film remains intact with no sign of fragmentation. This could indicate the stress transferred to the film surface has not exceeded its strength at this strain due to the elasticity of the polymer coating. Besides the short propagation length (˜30 μm) of the cracks, their width and depth detected by the profilometer were small as well. A depth profile across the surface along the indication line was presented in FIG. 5 in panel (b). It shows the width of a crack is in the range of <10 μm and extends ˜15 nm deep—or below the detectable limit of the equipment as the interferometry could not detect the entire depth of these narrow cracks. Still, the fracture behaviors of the polymer coating are distinct from that of inorganics under the same strain state regardless of thickness. The 250 nm-MgF2 coated sample strained to ε=1.64% was again compared to the polymer film morphology; the corresponding images are provided in FIG. 5 in panel (d). As seen, the cracks on MgF2 were much longer, wider, and deeper than those on polymer film, and the coating, as well as other inorganic coatings, were fragmented into isolated pieces. In contrast, the iCVD polymer coating remained in one piece. The depth profiles of 250 nm-MgF2 coating at the same strained state (ε=1.64%) as the polymer is also shown in FIG. 5 in panel (e). In contrast to that of the polymer, the profile of MgF2 shows a crack width of about 50 μm wide and at least 150 nm deep. These results illustrate that not only are polymer films more resistant to cracking under biaxial strain, but even when crack do form with repeated application of extreme strain, only small cracks form that do not span the entire coating and most of the film remains intact. Starting with substrates possessing higher surface quality and less ‘pinhole’-like defects, even higher resistance to fracture of the polymer coating may be achieved.

In addition, a ‘crack closure’ behavior of the polymer coating was observed. FIG. 5 in panels (c) and (f) showed the surface of both the polymer coating and the MgF2 coating after being released from the high strain state (ε=1.64%) to a lower strain (ε=0.3%). Surprisingly, the cracks in the polymer film appear to fully close at this state of strain; they essentially disappear and cannot be resolved in the profilometer. An image of the coating after the strain was fully released (ε=0%) is presented in Fig. S11 and shows no sign of cracks as well. The cracks in MgF2, however, do not fully close and the shattered fragments do not reconsolidate into a uniform, isotropic film. The cracks remain even after the release of strain, with a narrowed yet substantial width. The depth profile along the same line after the strain was reduced to 0.3% is shown in Fig. S12 where the crack was still at least 60 nm deep. The other two inorganic coatings, SiO2 and Al2O3, demonstrated a similar behavior (shown in Fig. S13 in panels (a) and (b), respectively) despite being thinner. Due to the flexibility of polymer films, these polymeric ARCs can be considered “self-healing,” as observed and reported before [73]. In optical applications, this is a desirable property as cracks can scatter light and compromise optical performance. The “self-healing” crack closure allows polymer coating formed according to this patent specification to maintain its optical design, such as antireflection, even after aggressive abuse conditions.

### Antireflection Effect

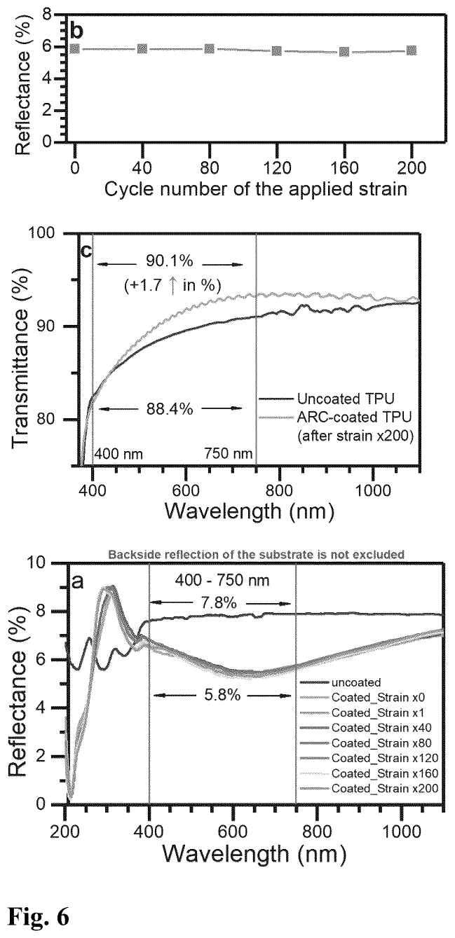

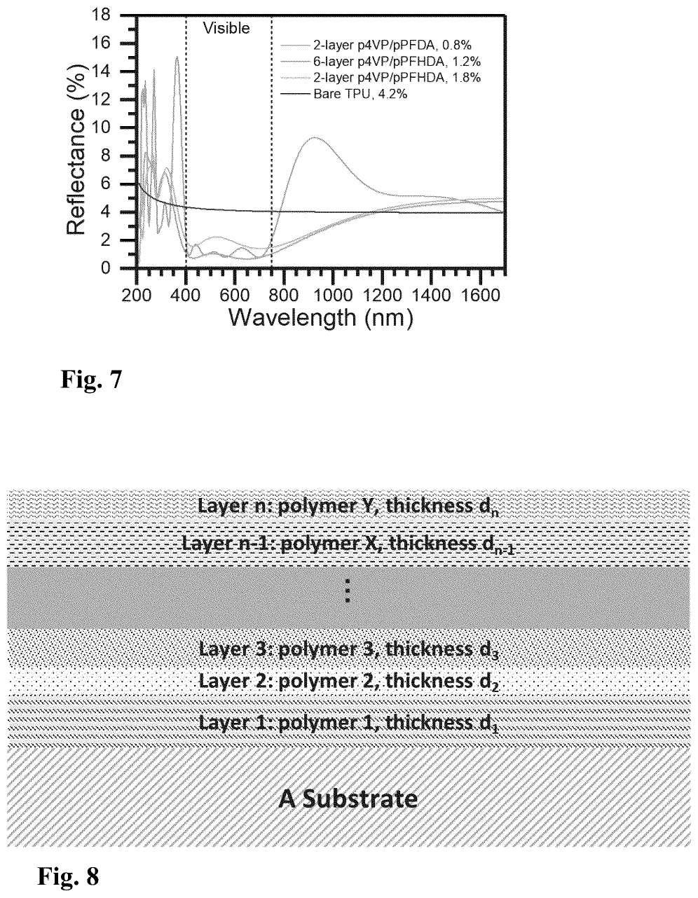

The reflectance of the TPU membrane with and without the two-layer polymer ARC is presented in FIG. 6 in panel (a). The reflectance spectra include reflection from the front surface, which was coated by iCVD, and the uncoated backside. The refractive index of the TPU is 1.51 at 633 nm, and its dispersion spectrum is seen in Fig. S14. The calculated reflectance spectra of the bare TPU and coated TPU, with backside reflection (only considering primary backside reflection) are presented in Fig. S15, which was in good agreement with the experimental measurement. After the two-layer polymer ARC was applied to the front side of the TPU, the reflectance of visible light from 400 nm to 750 nm was reduced significantly from 7.8% to about 5.86% (including backside reflection). Correspondingly, the reduced reflectance excluding backside reflection of the TPU with ARC was calculated and displayed in FIG. 7.

The reflectance was monitored after the TPU coated with polymer ARC was aggressively strained (ε=1.64% equibiaxial) repeatedly to generate cracks. The reflectance spectra were reported every 40 times of the strain cycle in FIG. 6 in panel (a), while the evolution of the average reflectance at the visible wavelength range (400 to 750 nm) is plotted in FIG. 6 in panel (b). Stable reflectance was observed even after 200 cycles. The reflectance (still with backside reflection) recorded after 200 strain cycles is 5.73%, with only a slight drop of 0.14 percent point from that of the unstrained sample. This is likely due to dust accumulation and some imperfect closure of cracks increasing light scattering.

FIG. 6 in panel (c) shows the measured total transmittance of the same TPU sample with and without the two-layer polymer ARC. The uncoated TPU had a transmission of 88.4% in the visible range. The low transmittance is due to a combination of absorption, reflection, and scattering. With the coating, the transmittance increased to 90.1% over the visible range. The increase of 1.7 percentage points was in good agreement with the reflection reduction due to the polymer antireflection coating. It is notable that the transmittance of the coated TPU was measured after the sample was repeatedly strained 200 times. Corroborating the stable reflectance or lack of significant degradation/distortion of the reflectance spectra further reveals the durability of the two-layer polymer antireflection coatings on flexible optical devices that undergoes aggressive, cyclic strain.

The polymer interference coating described in this example consisted of only two layers; it is a model system designed primarily to understand the compatibility of polymeric ARCs with flexible, elastomeric substrates and to demonstrate the key processing advantages of iCVD. Thus, the antireflection performance achieved in this example is unoptimized, and superior performance (lower reflectance) can be achieved with optimized multilayer architectures and alternative polymer thin film compositions.

A 6-layer interference coating by the same polymers (p4VP and pPFHDA) with an alternating structure reduces the TPU reflectance to 1.17%, of which the spectrum was shown in FIG. 7. The calculated reflectance spectrum of the two-layer ARC constructed in this work with backside reflection excluded is also displayed in the plot as a reference. On the other hand, there are polymers with refractive index lower than pPFHDA reportedly to be deposited by iCVD, such as poly(1H,1H,2H,2H-perfluorodecyl acrylate) (pPFDA). It has a refractive index of 1.38 at 633 nm. Substituting pPFHDA in the two-layer ARC with pPFDA alone without adding layers can reduce the reflectance to 0.85% (shown in FIG. 7). With a simple polymer two-layer ARC, about 80% the reflection at the visible range can be eliminated and can be enhanced even further with more layers.

To further explore the potential of polymer interference coatings, the effect of additional layers in the multilayer design and greater index contrast was simulated. Unlike solvent-based coating methods, multiple polymer layers can be readily deposited atop previous layers by iCVD without concerns over swelling or dissolution of the coatings, and precise thickness of each layer can be realized using in situ ellipsometry or QCM, for example. The layered structures of each optical design are detailed in Table S1 below:

TABLE S1
Layer structures of the designed interference
coating coatings in reflectance simulation

| LAYER # | 2-LAYER | | |
|---|---|---|---|
| FROM | P4VP/PPFHDA | 6-LAYER | 2-LAYER |
| SUBSTRATE | (THIS WORK) | P4VP/PPFHDA | P4VP/PPFDA |
| 1 | p4VP 163 nm | p4VP 187 nm | p4VP 159 nm |
| 2 | pPFHDA 96 nm | pPFHDA 22 nm | pPFDA 97 nm |
| 3 | — | p4VP 190 nm | — |
| 4 | — | pPFHDA 180 nm | — |
| 5 | — | p4VP 84 nm | — |
| 6 | — | pPFHDA 91 nm | — |
| TOTAL | 259 | 754 | 256 |
| THICKNESS | | | |
| REFLECTANCE | 1.8% | 1.2% | 0.8% |
| (CALCULATED | | | |
| ON TPU) | | | |

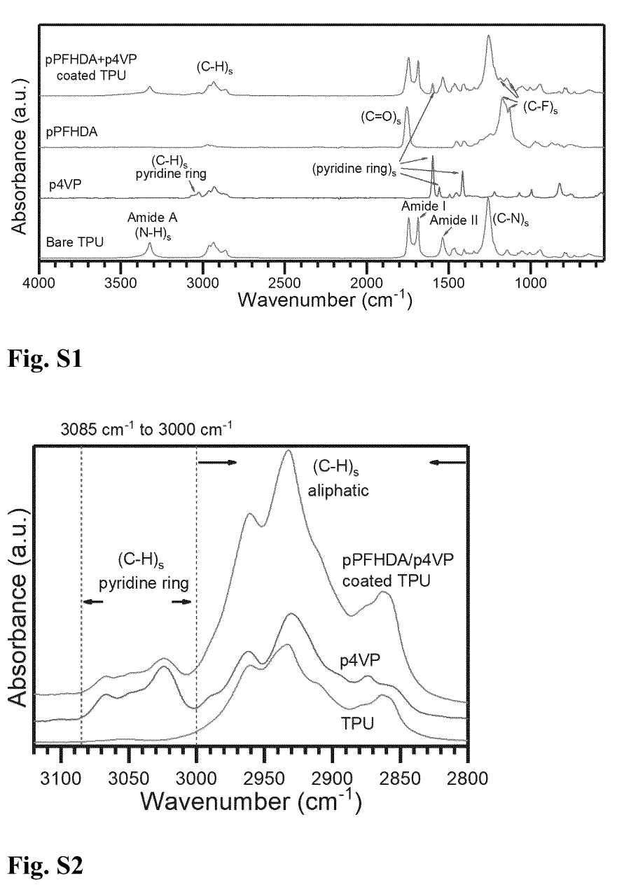

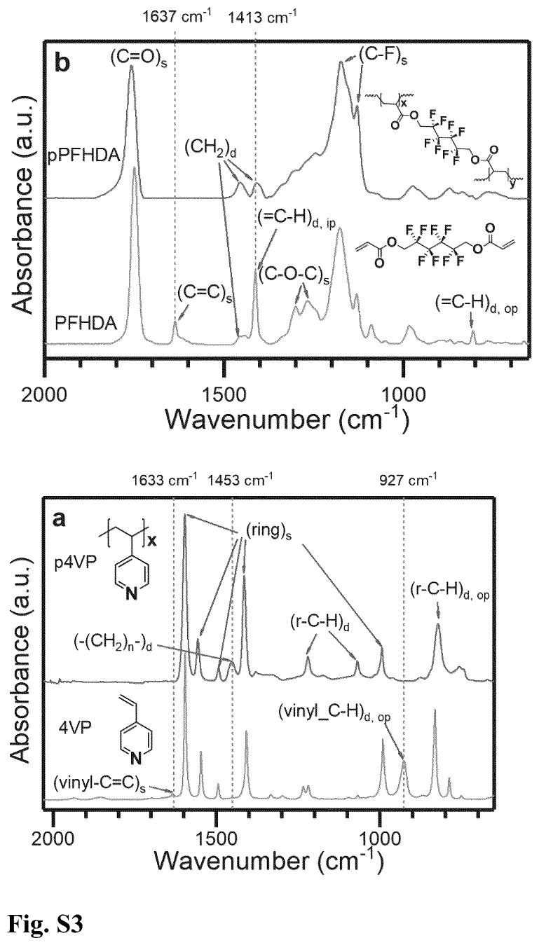

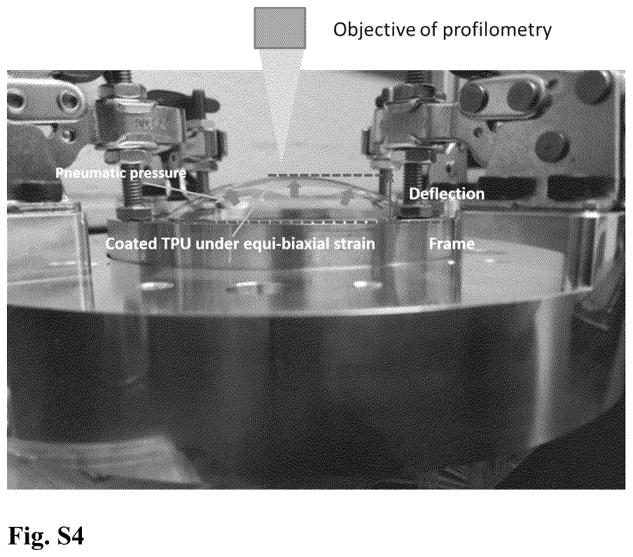

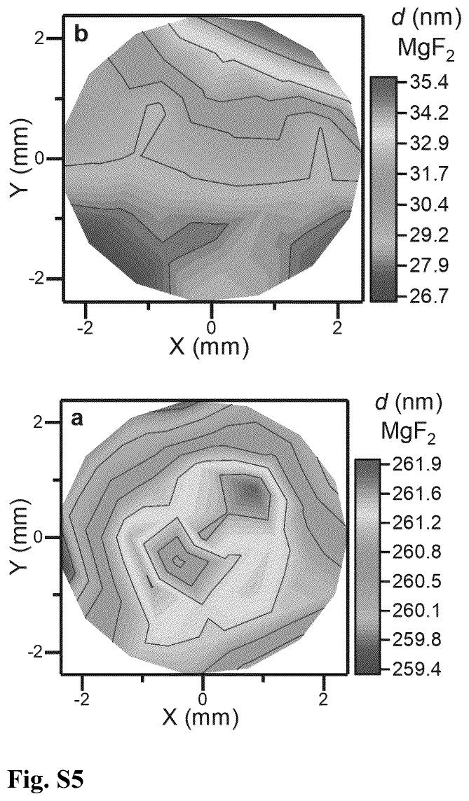

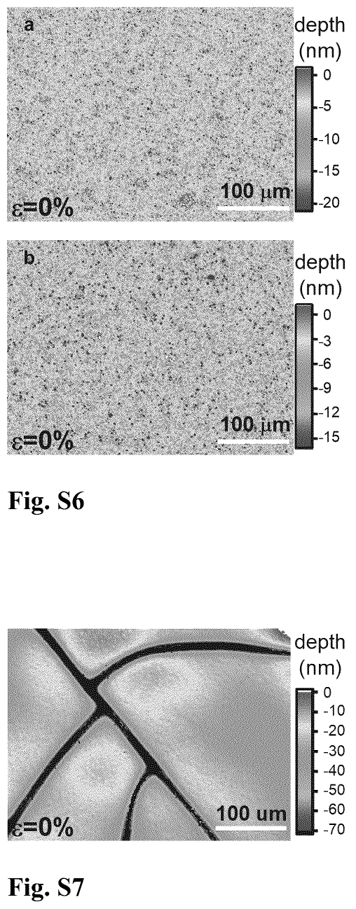

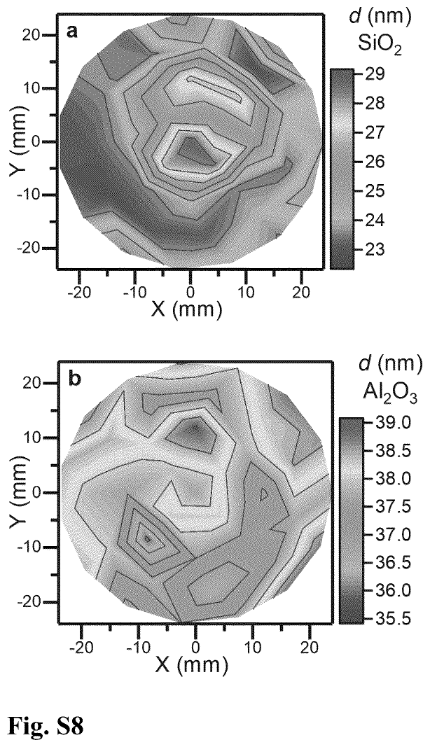

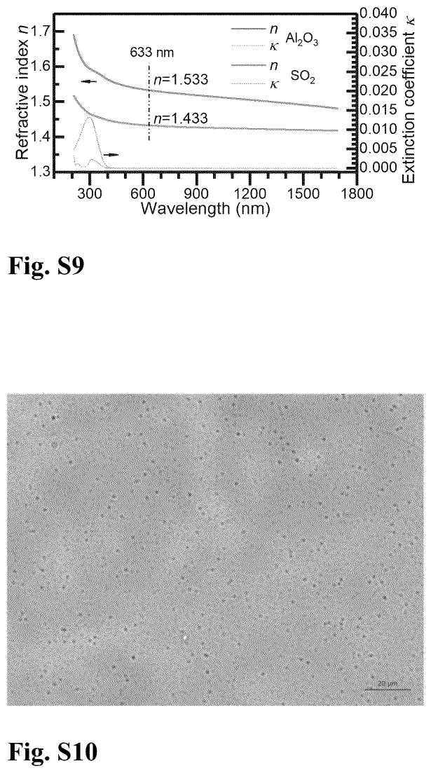

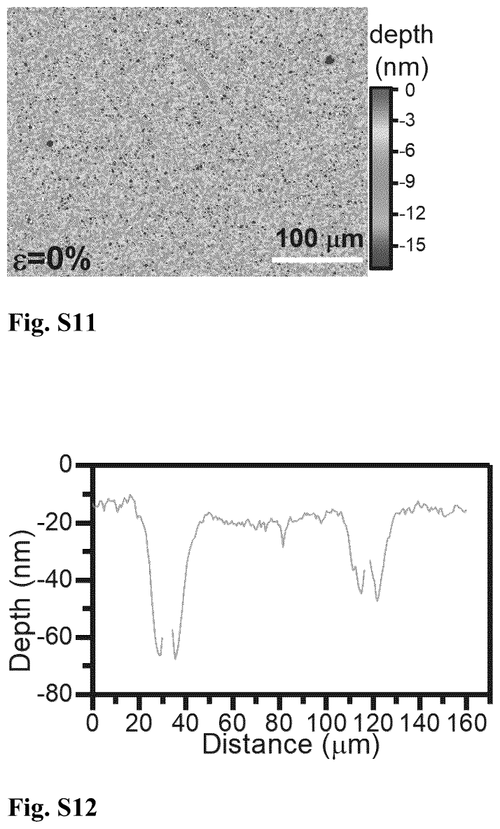

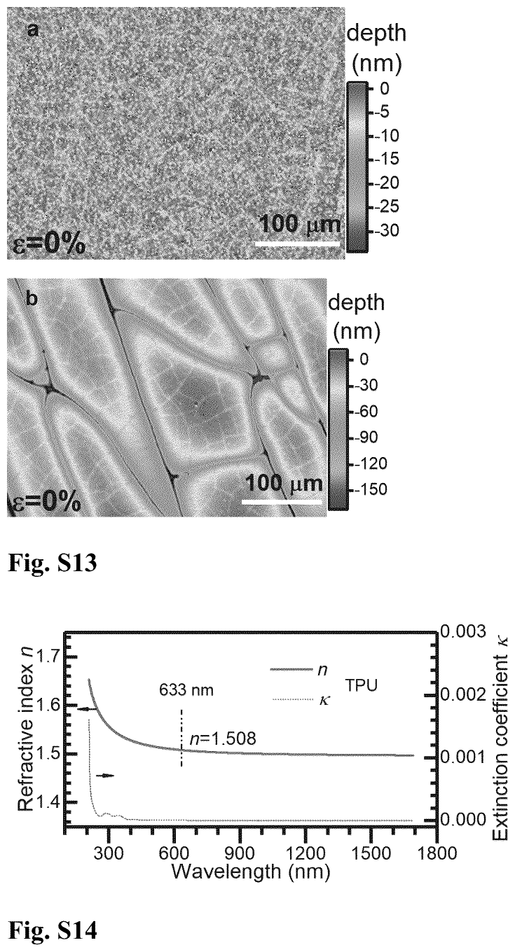

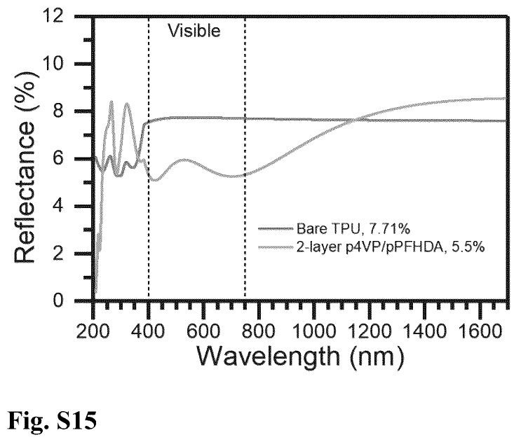

Deposition parameters of pPFDA: Chamber pressure: 1000 mTorr; monomer temperature: 25° C.; substrate temperature: 20° C.; Ar carrier gas flow for PFDA monomer: 50 sccm; initiator TBPO flow: 2 sccm; filament power: 46.5 W (0.7 A×66.4 V).The interference coating structure comprising layers of poly(4-vinylpyridine) (P4VP) and poly(1H,1H,6H,6H-perfluorohexyl diacrylate) (pPFHDA) or poly(1H,1H,2H,2H-perfluorodecyl acrylate) (pPFDA) appearing in Table S1 is an example of coatings. As indicated above, the iCVD approach to synthesizing multilayer interference coating applies to coatings using an arbitrary number of layers and film compositions. The AR coating design does not necessarily require the repetition of two materials; the AR coating can be fabricated using more than two materials. Moreover, each independent layer in the multilayer stack can be prepared with a unique polymer composition and a unique thickness. FIG. 8 illustrates an arbitrary design of a multilayer coating fabricated using the iCVD technique described above, modified by using respective sources of 3 of more monomers rather than only the sources of monomers A and B shown in FIG. 1A and a desires sequence of supplying the monomers to the reaction chamber. The multilayer can have “n” layers, where n=1, 2, 3, . . . , N and N is a positive integer. The composition and thickness of each layer “n” can be independently controlled in iCVD to satisfy a design specification.

A broad array of film compositions can be prepared by iCVD to serve as layers in the structure of FIG. 8. Fluorocarbon, organosilicon, acrylate, methacrylate, styrenic, and other vinyl monomers are examples that can be polymerized using iCVD. Examples of monomers from each class include hexafluoropropylene, tetravinyltetramethyltetrasiloxane, butyl acrylate, butyl methacrylate, divinylbenzene, and vinyl pyrrolidone. A comprehensive list of monomers that can be deposited using iCVD (as of 2015) can be found in reference [74]. To prepare multilayers, monomers are introduced sequentially into the deposition chamber and the deposition parameters are adjusted accordingly to control the deposited film properties. Moreover, the flow of multiple monomers can be combined to prepare a copolymer. The copolymer compositions are controlled through various deposition parameters. In essence, an infinite number of copolymer compositions can be prepared using this approach. The structure of FIG. 8 can include two or more layers that are the same material, or each layer material can be different from that of the other layers. A layer can have the same thickness as one or more other layers, or each layer can have a thickness different from that of the other layers.

### CONCLUSION

Compliant, optical-quality polymer thin films were shown to enable multilayer interference coatings that can accommodate deformation strain in elastomeric optical elements. A two-layer polymeric ARC was deposited by iCVD for the first time to applicant's knowledge. The solvent-free nature of iCVD is important as it allows the fabrication of complex multilayer designs with high thickness precision, while avoiding processing challenges and residual stresses associated with conventional solution processing. Moreover, the polymer interference coating design did not require complex surface texturing or patterning. In contrast to conventional inorganic optical layer materials (MgF2, SiO2, and Al2O3), film fracture was not observed in the polymer ARC up to an extreme equibiaxial strain of 1.64%. Through mechanical cycling of the optical element to this extreme over 200 cycles, minute film fracture was observed, which originated at point defects in the underlying TPU substrate. But as the strain was released, the fracture cracks underwent “crack closure” and become undetectable by optical interference profilometry. This contrasted inorganic coatings, where large cracks remained after relaxation of substrate deflection. Finally, simulations of relatively simple ARC designs with established iCVD polymer chemistries showed that broadband reflection of typical optical substrates (n633˜1.51) can be reduced from 4% to <0.8% over the visible wavelength range. Through the development of polymer compositions with even greater index contrast and the optimization of multilayer designs, this reflection can be further reduced. With the ability to readily tune composition-structure-property relationships in polymers, iCVD-enabled multilayer interference coatings are a compelling alternative to conventional optical coating designs for the next generation of flexible optics and optoelectronics.

### Experimental Section

Film synthesis: A custom-built vacuum system was used to execute initiated chemical vapor deposition (iCVD). A 35×30×10 cm stainless steel reaction chamber was connected to a rotary vane vacuum pump. The pressure in the reaction chamber was monitored and controlled by a pressure gauge (Brooks, XacTorr CMX100) and a downstream throttle control valve (MKS 653B) connected by a digital pressure controller (MKS 600 Series). A hot filament array (Master Wire, Nichrome 80) was fixed 2.5 cm above a temperature-controlled stage (˜16×15×2 cm) with a power of 46.5±0.4 W (0.7 A×66.4±0.6 V) provided by a DC power supply (TDK Lambda, GEN 150-5-USB-U). The temperature stage (aluminum base, copper surface) (Wieland MicroCool) was back-chilled by a recirculation chiller/heater (VWR, AD07R-20) to maintain a constant substrate temperature. Flows of carrier gas (MKS, Type 1179), diluent gas (MKS, Type 1479A), and initiator (Horiba STEC, SEC-4400) was regulated by mass flow controllers. Argon (Airgas, high purity grade) was used as the carrier and diluent gas.

Aliphatic thermoplastic polyurethane (TPU) membranes were provided by Sheedom Co. TPU was stretched and fixed to a round stainless-steel ring using a Schmidt ring press. The back side of the ring was embedded with an to ensure gas-sealing so the membrane can be deformed pneumatically. The TPU membrane was 7.7 cm in diameter with a thickness measured to be about 230 μm by a micrometer. During the deposition, the TPU membrane was placed on a copper base, making a solid contact between the temperature-controlled stage and the substrate to ensure thermal transport. The temperature stage was kept at 35° C. 1H,1H,6H,6H-perfluorohexyl diacrylate (PFHDA, SynQuest Laboratories, 99% purity) and 4-vinylpyridine (4VP, ACROS, 97% purity) were kept in monomer jars immersed in a 25° C. water bath (Cole-Parmer, StableTemp WB05). Di-tert-butyl peroxide initiator (TBPO, Acros Organics, 99% purity) vapor flow rate was fixed at 2 sccm. The p4VP was deposited on the TPU first, with a carrier gas flow at 5 sccm and diluent gas 10 sccm. The deposition rate was around 1.7 nm/min. The thickness was in situ monitored by a laser interferometry. After the target thickness of p4VP was reached, the flow of 4VP was stopped and the chamber was pumped down to base pressure with 100 sccm pure argon purging for 1 min. Shortly, the carrier gas of PFHDA was turned on at a flow rate of 50 sccm and the diluent gas flowed at 100 sccm to coat the second layer—pPFHDA. The deposition rate of pPFHDA was about 1.0 nm/min. The chamber pressure was kept at 750 mTorr during the deposition of both polymers.

Inorganic coatings, MgF2, SiO2, Al2O3, were all prepared by electron beam deposition (e-beam) in a Kurt J. Lesker PVD-75 deposition chamber. The deposition target materials were placed in a graphite crucible, and the TPU sample was fastened on the substrate holder above the target. The chamber was pumped down to 5×10−6 Torr before each deposition. The e-beam currents for MgF2, SiO2, and Al2O3 were about 0.5 mA, 12 mA, and 50 mA, respectively; a slow deposition rate around 0.5 Å/s was maintained to achieve a high-quality optical-grade film. 1.5 sccm O2 and 0.75 sccm Ar were introduced to create an oxidizing environment for SiO2 and Al2O3 depositions to compensate for possible oxygen loss and maintain the nominal stoichiometry. The chamber pressure during e-beam depositions is around 5×10−5 Torr for MgF2 and 2.5-3.5×10−4 Torr for the oxides. The thickness of the inorganic coatings was monitored by a quartz crystal microbalance (QCM) inside the chamber during the deposition and also characterized by ellipsometry directly on TPU after the deposition.

Material characterizations: Fourier transform infrared spectroscopy (FTIR) was conducted on Thermo Fisher Scientific Nicolet iS50. The spectra of TPU coated with the p4VP and pPFHDA double layer, the uncoated TPU, pure p4VP, pure pPFDA, and pure 4VP and PFHDA monomers were all characterized by attenuated total reflectance (ATR, Specac GoldenGate) with the ATR correction applied. The pure polymers of p4VP and pPFHDA were scratched from a monolayer coating deposited on a Si wafer at the same condition as the two-layer deposition on TPU. For all measurements, the resolution was set to 4 cm−1 and a total of 64 scans were integrated to improve the signal-to-noise ratio of the spectra.

The optical constants and the film thicknesses were characterized by ellipsometry (J. A. Woollam RC2). The complex refractive index of pPFHDA and p4VP coatings was resolved from ellipsometry data collected at the full wavelength range from 210 nm to 1690 nm and at seven different incident angles (45°, 50°, 55°, 60°, 65°, 70°, 75°) from a single-polymer monolayer film (˜200 nm) coated on a Si wafer; the multi-angle experiment was to improve the reliability and accuracy of the result. The thickness of p4VP/pPFHDA two-layer coated on TPU samples was collected at 70° incident angle with focus probes (J. A. Woollam) to compensate for intensity loss due to transmitted light and minimize backside reflections of the transparent TPU. The thickness of each layer was resolved with the known complex refractive index spectra pre-collected on the single-polymer monolayer film, and the wavelength range 400 nm to 1400 nm was used to calculate film thickness using a Cauchy model to avoid modeling complexities associated with absorption and interference from residual backside reflection.

Surface topography characterizations: White-light interferometry profilometer (Zygo, NewView 600) was used to examine the surface topography of the coatings. TPU membranes were fixed on a stainless-steel ring embedded with O-ring on its bottom. The side with coating was denoted as the front side. The backside of the membrane was pressurized pneumatically by a custom-built ‘bulging’ device to deflect the membrane and generate strain. The membrane deflection was measured by a laser profiler (Keyence, LJ-X8080), and the pressure was recorded by a pressure gauge (Dwyer DPGAB-04). An equi-biaxial strain of the pneumatically deformed membrane can be calculated using the following Equation (1):

$$ℰ = \frac{\sqrt{A} - \sqrt{{A}_{0}}}{\sqrt{{A}_{0}}} = \frac{\sqrt{2 π r h} - \sqrt{π {a}_{0}^{2}}}{\sqrt{π {a}_{0}^{2}}} \qquad ( 1 )$$

where A is the membrane area in the deformed state and A₀ is the membrane area in the undeformed state (A₀=46.57 cm2). The a₀ is the radius of the membrane in the undeformed state (a₀=3.85 cm). Assuming a geometrical relation for a spherical cap, valid for a small strain, one can calculate A from the radius of curvature, r, and the measured deflection, h. r can be calculated using h and a, as shown in Equation (2):

$$r = \frac{{a}_{0}^{2} + {h}^{2}}{2 h} \qquad ( 2 )$$

For in situ monitoring of the surface topography of the coating, the TPU and the ‘bulging’ device were placed under the objective lens of the Zygo profilometer. The strain was then generated pneumatically and determined by the pressure reading which had been calibrated against the deflection previously in the laser profiler. The profilometer was focused on the surface of the TPU at each targeted strain individually after the pressure was stabilized and the vibration was dissipated. The same area of 400×300 μm was imaged during the strain increasing. Filmetrics ProfilmOnline platform was used to process the imaging data. The images were flattened using forth-order fitting and artificial interference patterns caused by persistent vibrations were also removed. No smoothing algorithm was used to preserve the original surface information. Bare TPU was also imaged using Zeiss optical microscope.

Reflectance measurement: The reflectance of the TPU was measured by reflectometry (Filmetrics F-20 UV) at normal incident. The same TPU was measured before and after the AR coating. The reflection from the front (coating) side and the uncoated backside were both included in the reflectance spectrum. The reflectometer is properly baselined before each measurement using a standard Si wafer placed at the same distance as the TPU membrane from the probe to ensure a consistent intensity.

Transmittance measurement: The transmittance of the coated and uncoated TPU was measured by ellipsometry (J. A. Woollam, RC2) in transmission mode. Baseline was collected before each measurement.

Simulation: The reflectance simulation of TPU substrate coated with different multi-layer polymer ARCs was conducted by CompleteEASE ellipsometry software from J. A. Woollam (version: 6.61). All reflectance data are at normal incident angle. The optical constants of TPU for the simulation were collected by ellipsometer at 45°, 50°, 55°, 60°, 65°, and 70° incident angles (reflection), and transmission mode. The optical constants of pPFHDA, pPFDA, p4VP and TPU were used as input variables for the simulation. A pPFDA film was deposited on Si wafer so its spectrum of the complex refractive index can be precisely obtained by ellipsometry. The deposition parameters is available at the end of supplementary information.

The embodiments disclosed herein can be combined in one or more of many ways to provide improved flexible coatings. The disclosed embodiments can be combined with prior methods and apparatus to provide improved coatings. While preferred embodiments have been shown and described herein, it will be apparent to those skilled in the art that such embodiments are provided by way of example only. Numerous variations, changes, and substitutions will now occur to those skilled in the art without departing from the invention. Various alternatives to the embodiments of the invention described herein may be employed in practicing the new approach. It is intended that the following claims, as they may be amended in prosecuting this patent application, define the scope of the invention and that methods and structures within the scope of these claims and their equivalents be covered thereby.

### REFERENCES

1. H. K. Raut, V. A. Ganesh, A. S. Nair, and S. Ramakrishna, Energy & Environmental Science 4, 3779-3804 (2011).
2. Z. Han, Z. Jiao, S. Niu, and L. Ren, Progress in Materials Science 103, 1-68 (2019).
3. N. Shanmugam, R. Pugazhendhi, R. M. Elavarasan, P. Kasiviswanathan, and N. Das, Energies 13 (2020).
4. M. Moayedfar, and M. K. Assadi, REVIEWS ON ADVANCED MATERIALS SCIENCE 53, 187-205 (2018).
5. H. W. Yun, G. M. Choi, H. K. Woo, S. J. Oh, and S. H. Hong, Current Applied Physics 20, 1163-1170 (2020).
6. G. Tan, J.-H. Lee, Y.-H. Lan, M.-K. Wei, L.-H. Peng, I.-C. Cheng, and S.-T. Wu, Optica 4, 678-683 (2017).
7. Z. Zhao, B. K. Tay, and G. Yu, Applied Optics 43, 1281-1285 (2004).
8. C. Martinet, V. Paillard, A. Gagnaire, and J. Joseph, Journal of Non-Crystalline Solids 216, 77-82 (1997).
9. B. Richards, Solar Energy Materials and Solar Cells 79, 369-390 (2003).
10. X. Sun, X. Xu, J. Tu, P. Yan, G. Song, L. Zhang, and W. Zhang, “Research status of antireflection film based on tio2,” in IOP Conference Series: Materials Science and Engineering (IOP Publishing 2019), p. 022074.
11. H. Chatham, Surf. Coat. Technol. 78, 1-9 (1996).
12. K. L. Jarvis, and P. J. Evans, Thin Solid Films 624, 111-135 (2017).
13. P. C. With, U. Helmstedt, and L. Prager, Frontiers in Materials 7, 13 (2020).
14. G. John, S. R. Jadhav, V. M. Menon, and V. T. John, Angewandte Chemie International Edition 51, 1760-1762 (2012).
15. S. Cai, Z. Han, F. Wang, K. Zheng, Y. Cao, Y. Ma, and X. Feng, Science China Information Sciences 61, 060410 (2018).
16. S. R. Forrest, Nature 428, 911-918 (2004).
17. J. A. Rogers, T. Someya, and Y. Huang, Science 327, 1603 (2010).
18. H. Li, Y. Cao, Z. Wang, and X. Feng, Opt. Mater. Express 9, 4023-4049 (2019).
19. W. Vellinga, J. T. M. De Hosson, and P. Bouten, Journal of Applied Physics 112, 083520 (2012).
20. J. Hora, C. Hall, D. Evans, and E. Charrault, Advanced Engineering Materials 20, 1700868 (2018).
21. U. Schulz, and N. Kaiser, Progress in Surface Science 81, 387-401 (2006).
22. J. W. Gooch, “Refractive index table of polymers (letter r),” in Encyclopedic dictionary of polymers, J. W. Gooch, ed. (Springer New York, 2011), pp. 605-605.
23. R. R. Reddy, Y. Nazeer Ahammed, K. Rama Gopal, and D. V. Raghuram, Optical Materials 10, 95-100 (1998).
24. E. K. Macdonald, and M. P. Shaver, Polymer International 64, 6-14 (2015).
25. A. Musset, and A. Thelen, “Iv multilayer antireflection coatings,” in Progress in optics (Elsevier, 1970), pp. 201-237.
26. H. Jiang, W. E. Johnson, J. T. Grant, K. Eyink, E. M. Johnson, D. W. Tomlin, and T. J. Bunning, Chemistry of Materials 15, 340-347 (2003).
27. D. Langhe, and M. Ponting, Manufacturing and novel applications of Multilayer polymer films (William Andrew, 2016).
28. J. Bailey, and J. S. Sharp, Journal of Polymer Science Part B: Polymer Physics 49, 732-739 (2011).
29. T. Komikado, S. Yoshida, and S. Umegaki, Applied Physics Letters 89, 061123 (2006).
30. T. Komikado, A. Inoue, K. Masuda, T. Ando, and S. Umegaki, Thin Solid Films 515, 3887-3892 (2007).
31. A. L. Álvarez, J. Tito, M. B. Vaello, P. Velásquez, R. Mallavia, M. M. Sánchez-López, and S. Fernández de Ávila, Thin Solid Films 433, 277-280 (2003).
32. J. Bailey, and J. S. Sharp, The European Physical Journal E 33, 41-49 (2010).
33. M. F. Weber, C. A. Stover, L. R. Gilbert, T. J. Nevitt, and A. J. Ouderkirk, Science 287, 2451-2456 (2000).
34. K. D. Singer, T. Kazmierczak, J. Lott, H. Song, Y. Wu, J. Andrews, E. Baer, A. Hiltner, and C. Weder, Optics express 16, 10358-10363 (2008).
35. M. Li, W. Liu, F. Zhang, X. Zhang, A. A. A. Omer, Z. Zhang, Y. Liu, and S. Zhao, Solar Energy Materials and Solar Cells 229, 111103 (2021).
36. W. Schrenk, and T. Alfrey Jr, Polymer blends, 129-165 (1978).
37. S. Hansen, and T. Robitaille, Applied physics letters 52, 81-83 (1988).
38. D. B. Chrisey, A. Piqué, R. A. McGill, J. S. Horwitz, B. R. Ringeisen, D. M. Bubb, and P. K. Wu, Chemical Reviews 103, 553-576 (2003).
39. D. M. Mattox, Handbook of physical vapor deposition (pvd) processing (William Andrew, 2010).
40. H. Usui, “Formation of polymer thin films and interface control by physical vapor deposition,” in Nanostructured Thin Films II (International Society for Optics and Photonics 2009), p. 74040E.
41. H. Usui, Functional Polymer Films: 2 Volume Set, 287-318 (2011).
42. P. Sundberg, and M. Karppinen, Beilstein journal of nanotechnology 5, 1104-1136 (2014).
43. K. K. Gleason, Cvd polymers: Fabrication of organic surfaces and devices (John Wiley & Sons, 2015).
44. X. Li, X. H. Yu, and Y. C. Han, J. Mater. Chem. C 1, 2266-2285 (2013).
45. Z. Wang, H. Ding, D. Liu, C. Xu, B. Li, S. Niu, J. Li, L. Liu, J. Zhao, J. Zhang, Z. Mu, Z. Han, and L. Ren, ACS Appl Mater Interfaces 13, 23103-23112 (2021).
46. S.-I. Bae, Y. Lee, Y.-H. Seo, and K.-H. Jeong, Nanoscale 11, 856-861 (2019).
47. U. Schulz, Applied Optics 45, 1608-1618 (2006).
48. S. J. Yu, K. Pak, M. J. Kwak, M. Joo, B. J. Kim, M. S. Oh, J. Baek, H. Park, G. Choi, and D. H. Kim, Advanced Engineering Materials 20, 1700622 (2018).
49. A. M. Coclite, R. M. Howden, D. C. Borrelli, C. D. Petruczok, R. Yang, J. L. Yagüe, A. Ugur, N. Chen, S. Lee, and W. J. Jo, Advanced Materials 25, 5392-5423 (2013).
50. M. O. Mavukkandy, S. A. McBride, D. M. Warsinger, N. Dizge, S. W. Hasan, and H. A. Arafat, Journal of Membrane Science 610, 118258 (2020).
51. C. D. Petruczok, R. Yang, and K. K. Gleason, Macromolecules 46, 1832-1840 (2013).
52. Y. Zhao, N. Huo, S. Ye, A. Boromand, A. J. Ouderkirk, and W. E. Tenhaeff, Advanced Optical Materials 9, 2100334 (2021).
53. K. K. Lau, and K. K. Gleason, Macromolecules 39, 3688-3694 (2006).
54. K. K. Lau, and K. K. Gleason, Macromolecules 39, 3695-3703 (2006).
55. W. E. Tenhaeff, and K. K. Gleason, Advanced Functional Materials 18, 979-992 (2008).
56. G. Socrates, Infrared and raman characteristic group frequencies: Tables and charts (John Wiley & Sons, 2004).
57. Y. Leterrier, D. Pellaton, D. Mendels, R. Glauser, J. Andersons, and J.-A. Månson, Journal of Materials Science 36, 2213-2225 (2001).
58. J. Andersons, Y. Leterrier, and I. Fescenko, Thin Solid Films 434, 203-215 (2003).
59. L. Chen, M. Ghilardi, J. J. C. Busfield, and F. Carpi, Frontiers in Robotics and AI 8 (2021).
60. F. Xia, Z.-Y. Cheng, H. S. Xu, H. F. Li, Q. M. Zhang, G. J. Kavarnos, R. Y. Ting, G. Abdul-Sadek, and K. D. Belfield, Advanced Materials 14, 1574-1577 (2002).
61. Y. Leterrier, Progress in Materials Science 48, 1-55 (2003).
62. K. K. Rao, S. N. Naidu, and P. Setty, Acta Crystallographica 15, 528-530 (1962).
63. R. A. Orwoll, “Densities, coefficients of thermal expansion, and compressibilities of amorphous polymers,” in Physical properties of polymers handbook (Springer, 2007), pp. 93-101.
64. D. Bailey, F. Calderwood, J. Greiner, O. Hunter Jr, J. Smith, and R. Schiltz Jr, Journal of the American Ceramic Society 58, 489-492 (1975).
65. H. J. Qi, and M. C. Boyce, Mechanics of Materials 37, 817-839 (2005).
66. K. Kim, H. Luo, A. K. Singh, T. Zhu, S. Graham, and O. N. Pierron, ACS applied materials & interfaces 8, 27169-27178 (2016).
67. N. Bowden, S. Brittain, A. G. Evans, J. W. Hutchinson, and G. M. Whitesides, nature 393, 146-149 (1998).
68. S. Yu, X. Zhang, X. Xiao, H. Zhou, and M. Chen, Soft matter 11, 2203-2212 (2015).
69. T.-X. Gao, Y.-D. Sun, Y.-F. Feng, and S.-J. Yu, Philosophical Magazine 96, 2943-2952 (2016).
70. J. Genzer, and J. Groenewold, Soft Matter 2, 310-323 (2006).
71. J. Y. Chung, T. Q. Chastek, M. J. Fasolka, H. W. Ro, and C. M. Stafford, Acs Nano 3, 844-852 (2009).
72. Y. Li, B. Fang, J. Zhang, and J. Song, Thin Solid Films 520, 2077-2079 (2012).
73. Y. Zhang, R. Yang, S. M. George, and Y.-C. Lee, Thin Solid Films 520, 251-257 (2011).
74. K. K. S. Lau, “Growth Mechanism, Kinetics, and Molecular Weight,” in CVD Polymers: Fabrication of Organic Surfaces and Devices, (Wiley-VCH, 2015), pp. 15-63.

What is claimed is:

1. An optical device with interference coating, comprising:
a flexible substrate; and
a polymer antireflection coating (ARC) integrated with the substrate to form therewith a flexible optical structure that remains crack-free after 100 or more strain cycles at 1% or greater strain;
wherein said interference coating comprises an in-situ synthesized layer of polymerized 4-vinylpyridine (p4VP) and an in situ synthesized layer of polymerized 1H,1H,6H,6H-perfluorohexyl diacrylate (pPFHDA) sequentially deposited on the substrate in an initiated chemical vapor deposition (iCVD) process.

2. The optical device of claim 1, in which the substrate comprises an aliphatic thermoplastic polyurethane (TPU) elastomeric substrate.

3. The optical device of claim 1, in which cracks in the interference coating caused by imperfections in the substrate and application of strain to the ARC exceeding a first strain threshold self-heal upon reduction of strain to below a second strain threshold.

4. The optical device of claim 3, in which the first threshold is ε=1% or more equibiaxial strain and the second threshold is less than ε=0.3% equibiaxial strain.

5. The optical device of claim 1, in which the interference coating consists of only two layers, one comprising said p4VP and one comprising said pPFHDA.

6. The optical device of claim 1, in said interference coating comprises plural, alternating layers of said p4VP and pPFHDA.

7. The optical device of claim 1, in which the pPFHDA layer is over the p4VP and functions as a barrier layer.

8. The optical device of claim 1, in which the thickness of each said layer is under 200 nm and the areal variation in thickness of each layer is less than 3%.

9. The optical device of claim 1, in which said polymer interference coating has the property of withstanding at least ε=1.64% equibiaxial strain without fracture.

10. The optical device of claim 1, in which said polymer interference coating has the property of withstanding at least ε=1.64% equibiaxial strain over hundreds of cycles without fracture.

11. The optical device of claim 1, in which adding said ARC over the substrate reduces by at least 2% the reflectance of the device compared to reflectance of the substrate in the wavelength range of 400-1,000 nm.

12. The optical device of claim 1, in which adding said interference coating over the substrate increases by at least 1.5% the transmittance of the device compared to transmittance of the substrate in the wavelength range of 400-750 nm.

13. A method of forming an optical device with interference coating, comprising;
depositing a first monomer and an initiator to conformally deposit a first polymerized layer on a flexible elastomer substrate and depositing a second monomer and an initiator on the first polymerized layer for form a second polymerized layer;
wherein said first and second polymerized layers form a flexible interference coating integrated with the substrate using an iCVD process; and
wherein said interference coating has the property of remaining crack-free after 100 or more strain cycles at ε=1% or more equibiaxial strain without fracture.

14. The method of claim 13, in which said first monomer comprises 4-vinylpyridine (4VP) and said second monomer comprises 1H,1H,6H,6H-perfluorohexyl diacrylate (PFHDA).

15. The method of claim 13 in which said substrate comprises aliphatic thermoplastic polyurethane (TPU) elastomeric substrate.

16. The method of claim 13, in which said iCVD process comprises injecting a non-reactive gas into said first monomer when in liquid form to cause a forced vapor delivery of the first monomer over said substrate into a reaction chamber to form a layer of said first monomer on the substrate, introducing in said reaction chamber an initiator as vapor that is free of carrier gas and is heated to form gas-phase radicals to thereby polymerize the first monomer into said first polymerized layer, thereafter injecting said non-reactive gas into said second monomer when in liquid form to cause a forced vapor delivery of the second monomer into the reaction chamber and over said first polymerized layer to form a layer of said second monomer, and introducing in said reaction chamber the initiator as vapor that is free of carrier gas and is heated to form gas-phase radicals to thereby polymerize the second monomer into said second polymerized layer and form said ARC.

17. The method of claim 13, in which said initiator comprises di-tert-butyl peroxide (TBPO).

18. The method of claim 13, in which said depositing is carried out at room or near-ambient temperature.

19. The method of claim 13, further including maintaining said substrate at a constant temperature during said depositing.

20. The method of claim 13, further comprising repeating said depositing step to form said interference coating comprising a repeating sequence of said first and second polymerized layers.

21. An optical device with interference coating, comprising:
a flexible elastomer substrate;
a first monomer conformally deposited over said substrate and polymerized in situ by an iCVD process to form a first polymerized layer over the substrate; and
a second monomer deposited over the first polymerized layer and polymerized in situ by an iCVD process to form a second polymerized layer;
wherein said first and second polymerized layers form a flexible interference coating integrated with the substrate; and
wherein said interference coating has the property of remaining crack-free after 100 or more strain cycles at ε=1% or more equibiaxial strain without fracture.

22. The optical device with interference coating of claim 21, further including one or more additional monomers sequentially deposited over the second polymerized layer and polymerized in situ to respectively form one or more additional polymerized layers, wherein said first and second and said one or more additional polymerized layers form said flexible interference coating integrated with the substrate.

24. The optical device with interference coating of claim 22, in which at least two of said first and second and said additional one or more polymerized layers have respective thicknesses that differ from each other.

25. The optical device with interference coating of claim 22, in which the material of at least two of said first and second and said one or more additional polymerized layers is the same.

26. The optical device with interference coating of claim 22, in which the material of each of said first and second and said one or more additional polymerized layers differs from that of every other layer.

27. The optical device with interference coating of claim 22, in which said monomers are selected from among fluorocarbon, organosilicon, acrylate, methacrylate, styrenic and other vinyl monomers.

28. The optical device with interference coating of claim 22, in which said monomers are selected from among hexafluoropropylene, tetravinyltetramethyltetrasiloxane, butyl acrylate, butyl methacrylate, divinylbenzene, and vinyl pyrrolidone.

29. The optical device with interference coating of claim 22, in which said first and second polymerized layers comprise an in-situ synthesized layer of polymerized 4-vinylpyridine (p4VP) and an in situ synthesized layer of polymerized 1H,1H,6H,6H-perfluorohexyl diacrylate (pPFHDA).
